(19) United States
(12) Patent Application Publication
(10) Pub. No.: US 2026/0133992 A1
(43) Pub. Date: May 14, 2026

(54) SYSTEMS AND METHODS FOR DATABASE CONFIGURATIONS USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: John Andres Lozes, Wilmington, DE (US); Tonya Kyra Miller, Charlotte, NC (US); Mohammad Saleem Gaziani, Plano, TX (US); Manonmani Palanichamy, Fort Mill, SC (US); Asha Thekkumpurath, Frisco, TX (US); Aravind Singtalur, McKinney, TX (US); Andrea M. Weisberger, Jacksonville, FL (US); Amer Ali, Jersey City, NJ (US); Aisha Jenkins, Atlanta, GA (US); Aaron Gee, Palm Coast, FL (US)

(73) Assignee: BANK OF AMERICA CORPORATION, CHARLOTTE, NC (US)

(21) Appl. No.: 18/944,509

(22) Filed: Nov. 12, 2024

(51) Int. Cl. G06F 16/27; G06F 16/11

(52) U.S. Cl. CPC G06F 16/273; G06F 16/128

(57) ABSTRACT

Systems, computer program products, and methods are described herein for database configurations using advanced computational models for data analysis and automated processing. The present disclosure is configured to receive a first container record including data associated with a container and store the first container record in a first database. The present disclosure is configured to receive a trigger, wherein the trigger causes a generation of a second container record. The present disclosure is configured to determine a difference between the first container record and the second container record. The difference may affect at least one of an application, a file, or an additional container associated with the container.

### TECHNOLOGICAL FIELD

Example embodiments of the present disclosure relate to database configurations using advanced computational models for data analysis and automated processing.

### BACKGROUND

There are significant issues associated with reconfiguration management of containers. Applicant has identified a number of deficiencies and problems associated with conventional systems for change detection of containers. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for database configurations using advanced computational models for data analysis and automated processing.

Embodiments of the present invention address the above needs and/or achieve other advantages by providing apparatuses (e.g., a system, computer program product, and/or other devices) and methods for database configurations using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the solutions as described in the present disclosure provides for receiving a first container record including data associated with a container. In some embodiments, the solution provides for storing the first container record in a first database. In some embodiments, the solution provides for receiving a trigger, wherein the trigger causes a generation of a second container record including data associated with the container, wherein the second container record is generated after the first container record. In some embodiments, the solution may provide for storing the second container record in a second database. In some embodiments, the solution may provide for determining a difference between the first container record and the second container record, wherein the difference affects at least one of an application, a file, or an additional container associated with the container.

In some embodiments, the trigger may include at least one of a periodic trigger, an action trigger, or a user trigger. In some embodiments, the periodic trigger may be based on a time interval. In some embodiments, the action trigger may be based on the container being reconfigured. In some embodiments, the user trigger may be based on a user causing the trigger to be initiated.

In some embodiments, the first container record may include a snapshot of the container including a copy of the container's state including file values, performance metrics, and error evaluations.

In some embodiments, the second container record may include a snapshot of the container comprising, in an instance in which the trigger is initiated, a copy of the container's state including file values, performance metrics, and error evaluations.

In some embodiments, the second container record may include a snapshot of the reconfigurations of the container made prior to an instance in which the trigger is initiated.

In some embodiments, determining the difference between the first container record and the second container record may include determining a change in performance between the first container record and the second container record.

In some embodiments, determining the difference between the first container record and the second container record may include using an artificial intelligence (AI) model to perform statistical calculations on the change in performance between the first container record and the second container record.

In some embodiments, the statistical calculations may include automated outlier techniques.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for database configurations using advanced computational models for data analysis and automated processing, in accordance with an embodiment of the disclosure;

FIG. 2 illustrates an exemplary generative AI subsystem 200, in accordance with an embodiment of the disclosure;

FIG. 3 illustrates an example embodiment of the pre-configuration container and the post-configuration container, in accordance with an embodiment of the disclosure;

FIG. 4 illustrates an example embodiment of the trigger causing a snapshot, in accordance with an embodiment of the disclosure;

FIG. 5 illustrates an example embodiment of the performance metric comparison performed by an AI model, in accordance with an embodiment of the disclosure; and

FIG. 6 illustrates a process flow for database configurations using advanced computational models for data analysis and automated processing, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In modern computing environments, containers are used to deploy and manage applications consistently across different environments. A container is a lightweight, standalone, and executable package that includes everything needed to run a piece of software. The container may include the software (e.g., the code), runtime, libraries, and dependencies. Containers may be isolated from the underlying operating system and other containers, allowing them to work with different environments, such as development, testing, and production environments. In this way, the containers may operate consistently regardless of the host system. Further, the isolation of the container may enhance security and also simplify the process of scaling applications.

In some cases, containers may be updated. When a container is updated or reconfigured, the container and the software within the container may be reconfigured. For example, a container that includes an application and application dependencies may undergo a reconfiguration that reconfigurations the container, the application, and/or the application dependencies. Conventionally, determining the changes between the containers after reconfiguration presents several challenges in modern computing environments.

For example, lack of change detection presents difficulties regarding tracking specific modifications within a container's system, application state, or configuration. Further, differentiating between intended and unintended changes is difficult using conventional methods. For example, differentiating between a configuration update and a corrupted file is a difficult task while using traditional change detection methods. These issues are compounded given the ever-growing complexity of modern container usage applications that involve inter-container dependencies. Therefore, systems and methods for database configurations using advanced computational models for data analysis and automated processing are introduced.

In some embodiments, the solution presented herein may receive a snapshot (e.g., a first container record) of a container in a pre-configuration state. The container may include an application and application dependencies (e.g., libraries, and the like used by the application to function). The snapshot may provide insight into the container's performance metrics, such as processing capabilities, memory usage, bandwidth potential, and the like. The container may then be reconfigured, which may involve updating the container, the application, and/or the application dependencies. In some embodiments, the reconfiguration of the container may generate a trigger, wherein the trigger initializes the system to generate a second snapshot (e.g., a second container record). In other embodiments, the trigger may be generated based on a passage of time (e.g., a periodic trigger) or a user interacting with the system to manually initialize the trigger (e.g., a user trigger). The snapshots may then be compared to determine a difference between the containers pre-and post-configuration. The snapshots may be compared using a variety of methods, including automated outlier techniques, which may illustrate differences in performance characteristics of the containers. In some embodiments, the system may determine that the post-configuration container should be implemented into a production environment.

What is more, the present disclosure provides a technical solution to a technical problem. As described herein, the technical problem includes difficulty in determining and confirming changes within containers after reconfiguration, including differentiating between intended and unintended reconfigurations. The technical solution presented herein allows for automated snapshot comparison techniques that efficiently detect changes in container states, application states, and configurations using advanced outlier detection techniques. In particular, a database configuration system (e.g., the system 130 as described herein) is an improvement over existing solutions to the problem of determining changes after container reconfiguration, (i) with fewer steps to achieve the solution, thus reducing the amount of computing resources, such as processing resources, storage resources, network resources, and/or the like, that are being used (e.g., minimizing redundant snapshot captures and unnecessary storage usage), (ii) providing a more accurate solution to problem, thus reducing the number of resources required to remedy any errors made due to a less accurate solution (e.g., avoiding the need for repeated container rollbacks due to undetected unintended changes), (iii) removing manual input and waste from the implementation of the solution, thus improving speed and efficiency of the process and conserving computing resources (e.g., automatically triggering snapshots and comparisons instead of relying on manual intervention), (iv) determining an optimal amount of resources that need to be used to implement the solution, thus reducing network traffic and load on existing computing resources (e.g., dynamically adjusting snapshot intervals based on resource consumption and system load). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the database configuration system as described herein is a solution to the problem of difficulty in accurately detecting and confirming changes within containers after reconfiguration. Further, the database configuration system may be characterized as identifying a specific improvement in computer capabilities and/or network functionalities in response to the database configuration system's integration to existing devices, software, applications, and/or the like. In this way, the database configuration system improves the capability of a system to automate snapshot comparisons and detect outliers in container performance metrics. Further, the database configuration system improves the functionality of networks in response to reducing the resources consumed by the system (e.g., network resources, computing resources, memory resources, and/or the like).

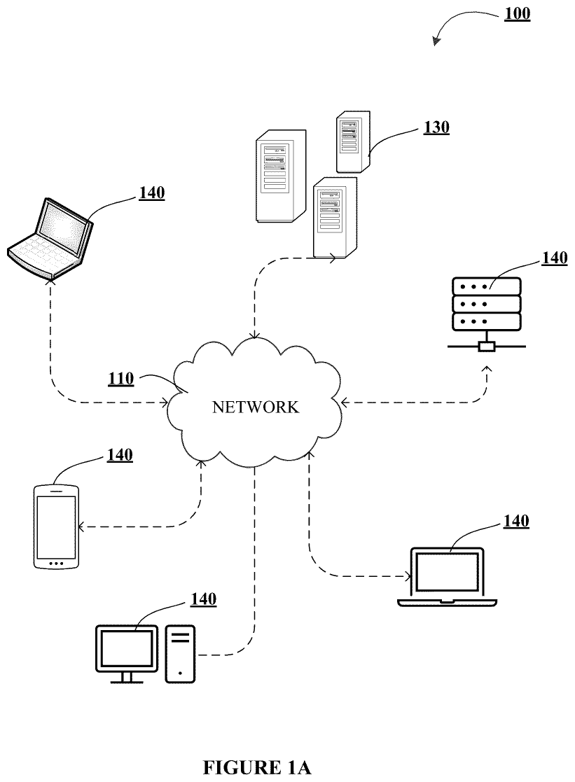

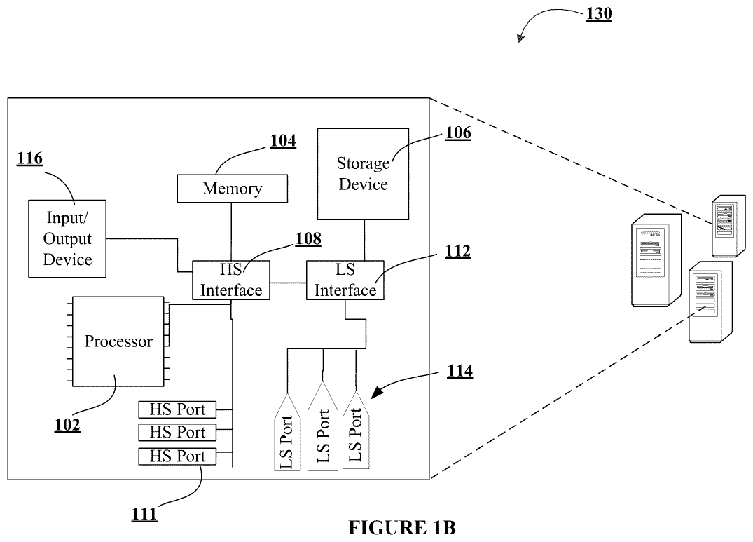

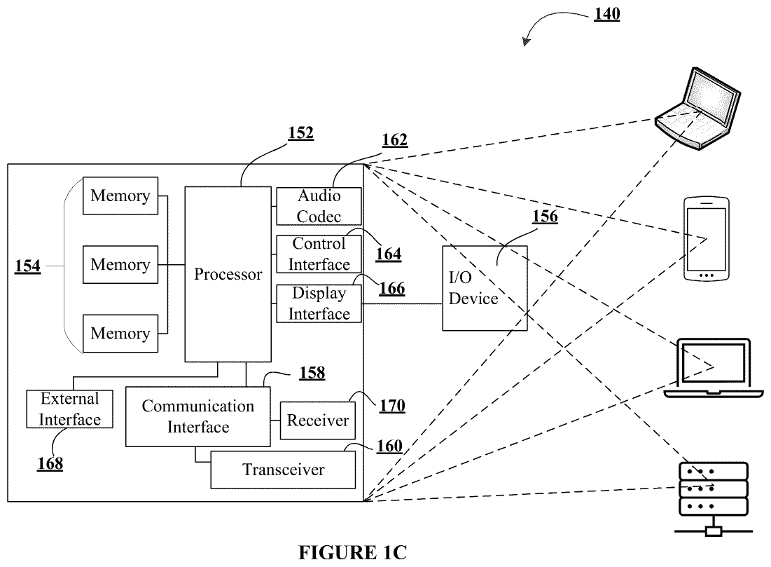

FIGS. 1A-1C illustrate technical components of an exemplary distributed computing environment 100 for database configurations using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140 The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

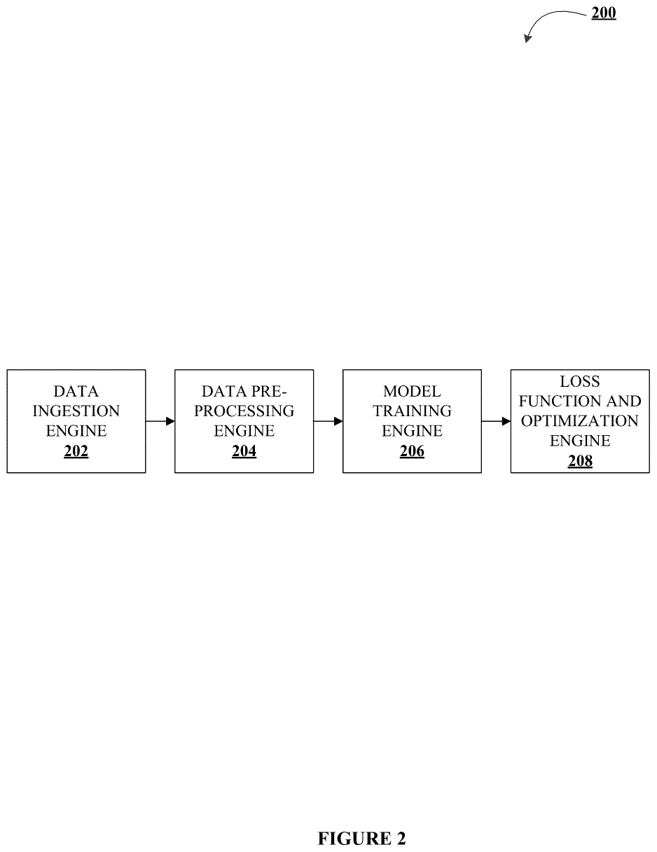

FIG. 2 illustrates an exemplary generative AI subsystem 200, in accordance with an embodiment of the invention. The generative AI subsystem 200 may include a data ingestion engine 202, a data pre-processing engine 204, a model training engine 206, and a loss function and optimization engine 208. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 202 may move the data to a destination for storage or further analysis. Typically, the data may be in varying formats as they come from different sources, including RDBMS, other types of databases, S3 buckets, CSVs, or from streams. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 204 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that are suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training module 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), or other generative models, depending on the specific requirements of the system. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data is used to update the model's parameters, while the validation and testing datasets are reserved to evaluate the model's performance during and after training. The model training engine 206 may support various data-handling strategies, such as cross-validation or random shuffling, to ensure that the model generalizes well and is not overfitting to the training data.

For VAEs, the model training engine 206 may implement an encoder-decoder architecture. In this architecture, the encoder is responsible for compressing or mapping the input data into a lower-dimensional latent space representation, capturing the essential features of the input data while discarding unnecessary details. The decoder, in turn, reconstructs the input data from this latent representation, aiming to recreate the original data as closely as possible. During training, the VAE model seeks to minimize a loss function that typically consists of two components: reconstruction loss and Kullback-Leibler (KL) divergence loss.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In embodiments using GANs, the model training engine 206 may train two distinct but interconnected networks: the generator and the determinator. The generator network is responsible for generating synthetic data samples, typically starting from random noise vectors or points sampled from a latent space. The generator's objective is to learn how to map this random input into realistic data that closely resembles the actual data distribution from the training set, such as images, financial plans, or any other domain-specific data. On the other side, the determinator network is tasked with differentiating between the real data-coming directly from the training set-and the synthetic data generated by the generator. The determinator acts as a binary classifier, aiming to correctly classify whether the input data is real or fake. Its job is to improve its accuracy over time in detecting whether the data it is evaluating comes from the true data distribution or has been synthetically created by the generator.

The training process of a GAN is adversarial in nature, where the two networks engage in a zero-sum match. The generator continuously tries to improve its ability to generate convincing data, while the determinator simultaneously improves its capacity to distinguish between real and generated data. During each training iteration, the generator attempts to “fool” the determinator by creating more realistic data samples, while the determinator receives feedback to better catch fake data. This adversarial feedback loop leads both networks to improve their performance over time. The loss functions for both networks guide this competition: the generator's loss reflects how well it was able to fool the determinator, while the determinator's loss reflects how accurately it classified real versus generated data. Through this iterative, competitive process, the generator becomes increasingly skilled at producing highly realistic data samples that are difficult for the determinator to differentiate from real data. Eventually, the generator learns to generate synthetic data that is nearly indistinguishable from the real data.

The model training engine 206 may include a parameter optimization module, which may optimize the model's parameters using gradient-based optimization techniques such as stochastic gradient descent (SGD), Adam, or other suitable algorithms. The optimization process may minimize the loss function calculated during each training iteration (or epoch), adjusting the weights and biases of the model to improve its ability to learn from the data. The parameter optimization module may also dynamically adjust learning rates, momentum, and other hyperparameters to further enhance training efficiency.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments where a VAE is used to train the generative AI model, generating new output involves providing an input to the trained model in the form of a point or distribution in the latent space. During training, the encoder network learned to compress input data into this latent space, while the decoder learned to map points from the latent space back into meaningful data. To generate new data, the system may sample a point from the latent space, typically by sampling from a predefined distribution (e.g., a Gaussian distribution), or a user may provide specific coordinates within the latent space to control the nature of the output. The decoder network then transforms this latent vector into a new data instance (e.g., an image or piece of text) that conforms to the patterns learned during training. Since the latent space has been structured to capture the key features of the input data, small variations in the latent space coordinates may result in new data with slight variations, allowing the system to produce diverse but coherent outputs.

In embodiments where the generative AI model has been trained using a GAN, the process for generating new output also involves providing an input in the form of a random noise vector sampled from the latent space. Unlike VAEs, where the latent space is learned explicitly during training, GANs use this latent space as a starting point for the generator to produce new data. The trained generator network takes the random input vector and transforms it into a new data sample, such as an image, based on the patterns it has learned during training. The determinator is no longer needed in this phase, as its role was limited to training. Once the generator has been trained to produce realistic outputs, it can generate new data by mapping random noise vectors to complex data points that resemble the original dataset. For example, in a GAN trained on images of landscapes, providing a random vector in the latent space will result in the generation of a new, never-before-seen landscape that adheres to the patterns the generator learned during training. The latent space in GANs encodes abstract features of the data, and small adjustments to the noise vector allow users to control specific aspects of the generated data, such as color, shape, or texture, enabling the generation of highly varied outputs.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

In some embodiments, a system for database configurations using advanced computational models for data analysis and automated process may include a processing device and a non-transitory storage device containing instructions when executed by the processing device, cause the processing device to perform the steps as described herein. For example, in some embodiments, the system and/or processing device may receive a first container record including data associated with a container.

As used herein, a “container” may be a standard unit of software that packages code and all of its dependencies so an application associated with the container may run efficiently and effectively from one computing environment to another. For example, a container may include a software package that may be loaded onto one or more computing environments and may include all of its dependencies, libraries, databases, and the like that are needed for the code within the container to operate. In this way, the code within the container may be an application that may or may not interact with other applications of the computing environment. Further, the code within the container may access the dependencies (e.g., libraries, for example) stored within the container for the code to function. Additionally, or alternatively, the code within the container may not need to interact, access, or query with other software outside of the container (e.g., associated with the computing environment) to function. It is to be understood, however, that the code and/or application(s) within the container may interact with the other software associated with the computing environment.

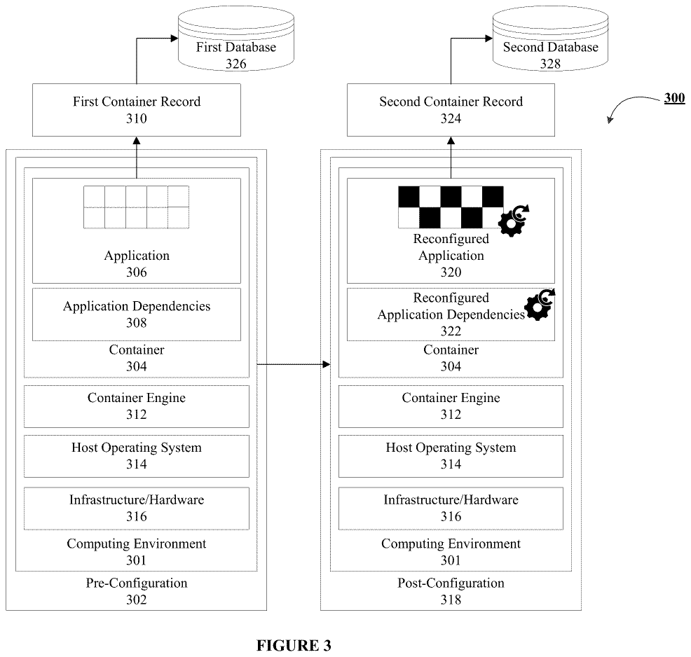

As illustrated in FIG. 3, in some embodiments, the container 304 may include an application 306 and associated dependencies 308, such as libraries, plugins, databases, cache storage, third-party services, servers, networks, and the like. The container 304 may be associated with a computing environment 301. The computing environment 301 may include a variety of computing environments that may be used to process or at least assist in processing data. In this regard, the computing environment 301 may be an environment in which data is received, stored, processed, transmitted, queried, aggregated, split, manipulated, or otherwise configured. For example, the computing environment 301 may be associated with a datacenter, a server, a local computer, a cloud computer, or the like, that may be used to process or at least assist in processing data. Additionally, or alternatively, in some embodiments, the computing environment 301 may be a part of a device, such as an end-point device 140 as described in FIGS. 1A-1C. In this regard, the computing environment 301 may be associated with a user device, a mobile phone, a laptop, a tablet, or the like.

Further, as shown in FIG. 3, the computing environment 301 may include infrastructure or hardware 316, a host operating system 314, and/or a container engine 312. In some embodiments, the hardware 316 may be the same as or similar to the hardware as described in FIGS. 1A-1C. In this regard, the hardware 316 may include components used by the computing environment 301 to initiate or run the application 306, or other code and/or software associated with the computing environment 301. Further, the host operating system 314 may include software used in combination with the hardware 316. The host operating system 314 may include software used to initiate specialized applications, code, or the like. For example, the host operating system 314 may initialize software that is used to run the application 306.

In addition, the container engine 312 may be an application, code, software or the like that is used to interact or configure the container 304. In this regard, the container engine 312 may be software that is used by the host operating system 314 to receive, store, initialize, or otherwise configure the container 304. Further, the container engine 312 may have the capability to interact with the container 304 and transform the container 304, if need be, into a language (e.g., code language) that may be used by the host operating system 314. For example, if the container 304 includes an application 306 programmed in a first language, and the host operating system 314 is programmed in a second language, the container engine 312 may be able to reconfigure the code associated with the container 304 and/or the application 306 to make it accessible by the host operating system 314.

In some embodiments, snapshots of a container may be generated. A snapshot may refer to an image, file, record, or the like of the container that may indicate the state of the container. For example, a container record may be a snapshot of the container and may include the state of the container at the moment the container record is generated. Further, the snapshots (or container records) may include, but is not limited to, data such as Yet Another Markup Language (YAML) files, performance metrics, CPU processes, memory status, volumes of inbound and outbound connections, error evaluations, and the like. In this regard, the state of the container may refer to the performance of the container at a point in time.

In some embodiments, the state of the container may be included in the first container record 310. For reference, and in some embodiments, the first container record 310 may be based on the container's 304 state in a pre-configuration 302 state. In this regard, the pre-configuration 302 state may include the container 304 as it exists before a configuration occurs. In this regard, the first container record 310 may illustrate the performance of the container 304 in a first state.

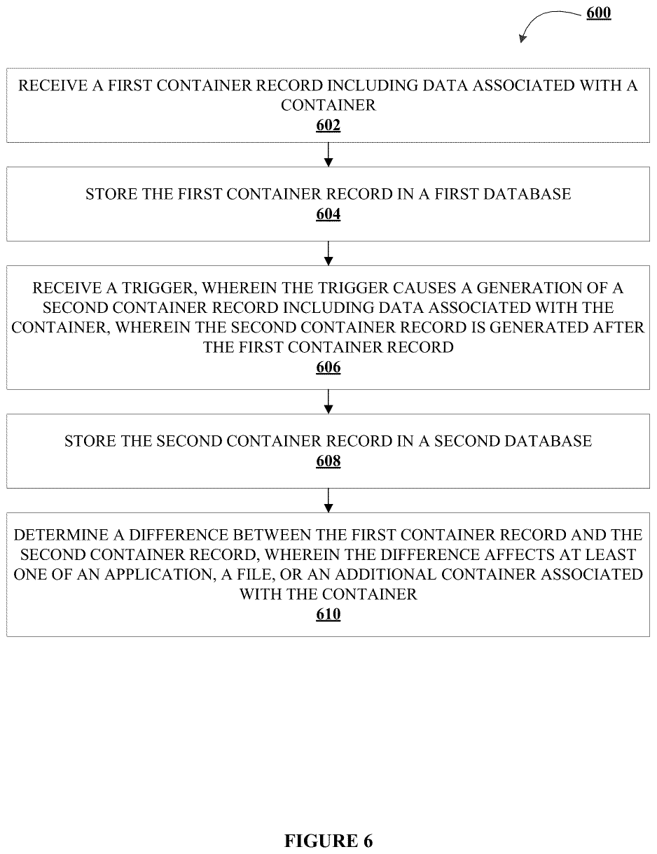

FIG. 6 illustrates a process flow for database configurations using advanced computational models for data analysis and automated processing, in accordance with an embodiment of the disclosure. The method may be carried out by various components of the distributed computing environment 100 discussed herein (e.g., the system 130, one or more end-point device(s) 140, etc.). As shown in block 602, the process flow 600 of this embodiment includes receiving a first container record including data associated with a container. In some embodiments, the first container record may include a snapshot of the container including a copy of the container's state including file values, performance metrics, and error evaluations. For example, in some embodiments, the snapshot may include a copy or duplicate of the container's 304 state. In some embodiments, the snapshot may include a copy-on-write (COW) snapshot or a redirect-on-write (ROW) snapshot. In some embodiments, the COW snapshot may create a snapshot or container record before the container (or any associated information, i.e., the application or application dependencies) are overwritten or reconfigured. In this way, for example, the COW snapshot may copy the container prior to the container being reconfigured. In some embodiments, the COW snapshot may copy only those portions of the container 304 that will be affected by the reconfiguration. In some embodiments, the ROW snapshot may create a new copy of the modified data by redirecting the write operation (e.g., the reconfiguration) to a new location, leaving the original container intact until it is no longer needed.

In some embodiments, the first container record 310 may indicate the container's 304 performance as the first container record 310 is generated. In this regard, the first container record 310 may include performance associated with the container's 304 interface with the computing environment 301 (e.g., via the host operating system 314), the application's 306 runtime performance metrics, the performance of the application dependencies 308, or any combination thereof. For example, the first container record 310 may include metrics associated with the ability of the application 306 to interact with a library of the application dependencies 308. In this example, the first container record 310 metrics may include the query latency which indicates the time taken by the application 306 to query the library.

In some embodiments, and as shown in block 604 of FIG. 6, the system may store the first container record in a first database. For example, as shown in FIG. 3, the first container record 310 may be stored in a first database 326. The first database 326 may be a database associated with the computing environment 301, which may include either local storage or non-local storage (e.g., cloud-based storage). Further, in some embodiments, the first database 326 may be a division, subset, or child of a main database. For example, the main database may contain file divisions, folders, subfolders, or the like that may be used as the first database 326. In this regard, the main database may divide the first database 326 based on structuring the first database 326 according to file or folder infrastructure within the main database.

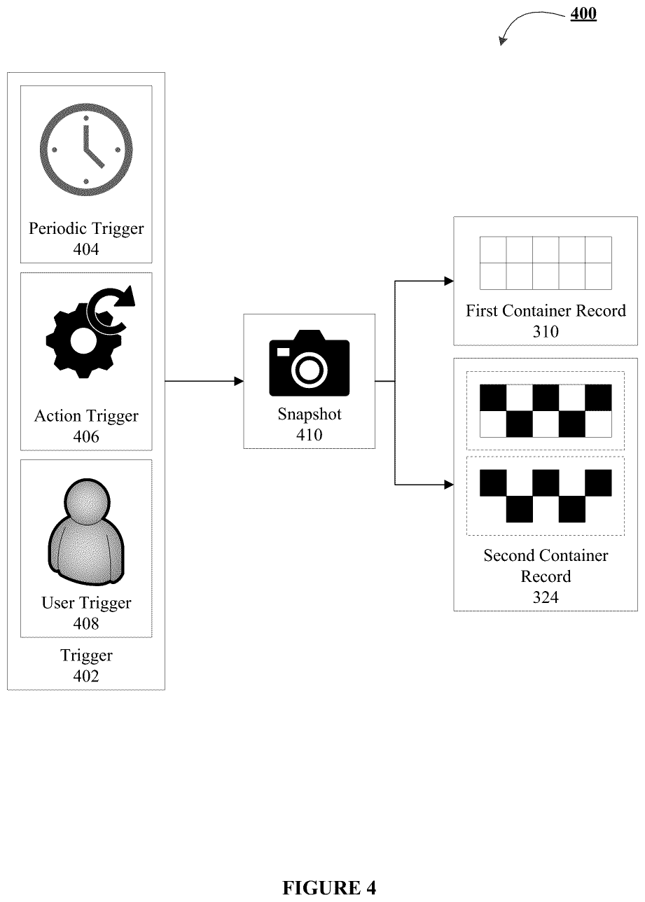

As shown in block 606 of FIG. 6, in some embodiments, the system may receive a trigger, wherein the trigger causes a generation of a second container record including data associated with the container, wherein the second container record is generated after the first container record. In some embodiments, the trigger may include at least one of a periodic trigger, an action trigger, or a user trigger. For example, as shown in FIG. 4, the trigger 402 may include a periodic trigger 404, an action trigger 406, or a user trigger 408.

In some embodiments, the periodic trigger may be based on a time interval. The periodic trigger 404 may be based on a time period, which may include a period in the range of seconds, minutes, hours, days, weeks, months, years, or the like. In this regard, and in some embodiments, the periodic trigger 404 may include causing the trigger on regular intervals, such as in one hour intervals. In other embodiments, the periodic trigger 404 may include causing the trigger on irregular intervals, wherein the periodic trigger 404 may cause the trigger based on random intervals.

In some embodiments, the action trigger may be based on the container being reconfigured. For example, the action trigger 406 may be based on the container 304 being reconfigured to become a reconfigured container, the application 306 being reconfigured to become a reconfigured application 320, or the application dependencies 308 being reconfigured to become reconfigured application dependencies 322. In this regard, the reconfiguration of the container 304, the application, 306, or the application dependencies 308 may cause the action trigger 406 to generate the second container record. Further, in some embodiments, and as shown in FIG. 3, the post configuration 318 may refer to a reconfiguration of the container 304, the application 306, or the application dependencies 308.

In some embodiments, the user trigger may be based on a user causing the trigger to be initiated. For example, the user trigger 408 may be initiated by a user associated with the system, wherein the user manually activates the trigger to generate the second container record 324.

Further, as the trigger 402 is initiated, a snapshot 410 may cause the generation of the first container record 310 or the second container record 324. Similar to the first container record 310, the second container record 324 may indicate the performance of the container 304 at a point in time when the second container record 324 is generated. In some embodiments, the second container record may include a snapshot of the container including, in an instance in which the trigger is initiated, a copy of the container's state including file values, performance metrics, and error evaluations.

In some embodiments, the second container record may include a snapshot of the reconfigurations of the container made prior to an instance in which the trigger is initiated. In this regard, and in some embodiments, the second container record 324 may include only the changes made to the container 304, the application 306, or the application dependencies 308. The second container record 324 including only the differences (e.g., reconfigurations) may reduce the file size of the snapshot 410 or second container record 324 used to store the information. Further, in some embodiments, when the system 130 analyzes the differences between the first container record 310 and the second container record 324, the system may combine the first container record 310 and second container record 324 and compare with just the first container record 310. In this way, the system 130 may determine the affects the reconfigurations have on the container 304.

Further, as shown in block 608 of FIG. 6 and in some embodiments, the system may store the second container record in a second database. For example, as shown in FIG. 3, the second container record 324 may be stored in a second database 328. In some embodiments, the second database 328 and the first database 326 may be the same database. In this regard, the second container record 324 may be stored in the same location as the first container record 310. Storing the container records in the same location (e.g., the main database) may increase efficiency of the system (e.g., the system 130 as described herein) as it accesses and uses the container records for further analysis, as described in greater detail below. For example, as the system 130 queries the main database for the first container record 310 and second container record 324, the storage of the container records in the same database may decrease the time taken to retrieve the container records.

In other embodiments, the second database 328 may be a division in a main database, as described above with respect to the first database 326. In this regard, the first database 326 and second database 328 may be two separate databases that may be access and queried by the system to retrieve the container records.

In some embodiments, and as shown in block 610 of FIG. 6, the system may determine a difference between the first container record and the second container record, wherein the difference affects at least one of an application, a file, or an additional container associated with the container. In some embodiments, determining the difference between the first container record and the second container record may include determining a change in performance between the first container record and the second container record.

In this way, the difference may include determining the difference between the first container record 310 and the second container record 324 as determined by the respective performance of each. For example, the difference may include the difference between CPU usage, memory usage, disk performance, network throughput, application latency, container start time, error evaluations, and the like. In some embodiments, a baseline may be established that may be include the performance associated with the first container record 310, which may include the state of the container prior to the configuration (e.g., the pre-configuration 302 state, as shown in FIG. 3). The baseline may act as a reference used to measure the changes in performance metrics as compared to after the configuration (e.g., the post-configuration 318 state) is applied.

For example, if the difference reveals increased CPU usage or memory consumption in the second container record, the system may flag this change as potentially impacting the application's performance. Additionally, or alternatively, the system may perform file integrity checks by using hashing algorithms to detect file modifications or anomalies. In some embodiments, if the difference indicates a misconfigured parameter, file corruption, or altered dependencies, the system may assess how the difference affects the application, connected files, or additional containers linked to the primary container (e.g., the container 304). In some embodiments, if the system detects a significant difference, which may include critical differences regarding performance in the post-configuration state, the system may rollback the container to the pre-configuration state.

In some embodiments, determining the difference between the first container record and the second container record may include using an artificial intelligence (AI) model to performance statistical calculations on the change in performance between the first container record and the second container record. In some embodiments, the absolute and relative differences may be calculated for both the pre-configuration 302 and the post-configuration 318. The absolute differences may measure the direct changes in a particular metric's value, while the relative difference may include other metrics that may be considered useful in the comparison. Additionally, or alternatively, trends and patterns within the data may be calculated, which may lead to a determination of the difference between the container records. For example, a reduction in memory usage may indicate an optimization of the resource management in the second container record 324. Further, the AI model may be used to calculate any and all of the differences, as well as assist in identifying trends and patterns mentioned herein. In this way, the AI model may ingest the data of the first container record 310 and the second container record 324 to determine a difference between the pre-configuration 302 state and the post-configuration 318 state. Further, in some embodiments, the AI model may be able to determine what differences optimize or hinder the container 304, application, and/or application dependencies 308. The AI model may then use this information to identify which reconfigurations should be kept and/or which reconfigurations should be reverted or updated to improve the container 304.

In some embodiments, the statistical calculations may include automated outlier techniques. The automated outlier techniques used may include statistical techniques (e.g., z-score, interquartile range, Grubb's test), distance-based techniques (e.g., Euclidean distance, Mahalanobis distance, k-nearest neighbor), density-based techniques (e.g., DBSCAN, local outlier factor), machine learning techniques (e.g., isolation forest, autoencoders), ensemble techniques (e.g., scoring-based methods), time-series specific techniques, clustering based techniques, or the like.

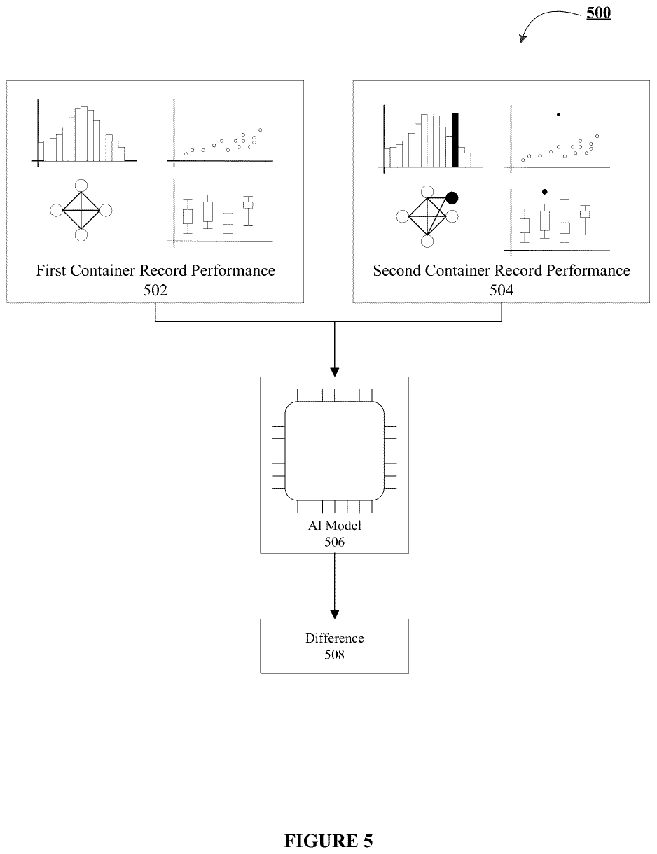

For example, as shown in FIG. 5, the AI model 506 may ingest or otherwise receive the first container record performance 502 and the second container record performance 504. In some embodiments, the first container record performance 502 may be the performance metrics associated with the first container record 310. In some embodiments, the second container record performance 504 may be the performance metrics associated with the second container record 324. In some embodiments, the AI model 506 may analyze the performance metrics of each of the record performances. In other embodiments, the AI model 506 may perform tests for each of the first container record 310 and the second container record 324 to determine the first container record performance 502 and the second container record performance 504. In this way, the container 304, in its pre-configuration 302 state and its post-configuration 318 state, may perform differently in response to the AI model's 506 tests.

Further, the analysis performed by the AI model 506 may indicate outliers (e.g., using the automated outlier techniques) between the first container record 310 and the second container record 324. In some embodiments, the outliers may be detected and analyzed by the AI model 506 to determine whether the reconfiguration(s) optimize or hinder the container 304. In some embodiments, the difference 508 between the two container records may be outputted by the AI model 506.

In some embodiments, the system may implement the container after it has been reconfigured to a production environment. In some embodiments, the system may determine that the difference (e.g., the difference 508) is a beneficial difference that optimizes the container 304, the application 306, or the application dependencies 308. For example, the reconfigured application 320 may be optimized in the number of CPU cycles taken to perform a task. In this example, the difference 508 may indicate that the reconfiguration has benefited the container 304 and should be implemented into production. Further, in other embodiments, the system may determine that the difference 508 has a net benefit for the container 304, the reconfigured application 320, or the reconfigured application dependencies, which should be implemented into production. In this way, the reconfiguration may include a positive impact in one area and a negative impact in another, but still may have an overall positive impact on the reconfigured application 320.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for database configurations using advanced computational models for data analysis and automated processing, the system comprising:
a processing device;
a non-transitory storage device containing instructions when executed by the processing device, causes the processing device to perform the steps of:
receive a first container record comprising data associated with a container, wherein the container comprises a standalone executable package;
store the first container record in a first database;
receive a trigger, wherein the trigger causes a generation of a second container record comprising data associated with the container, wherein the second container record is generated after the first container record;
store the second container record in a second database; and
determine, using an artificial intelligence (AI) model, a difference between the first container record and the second container record, wherein the difference affects at least one of an application, a file, or an additional container associated with the container, and wherein the difference indicates a change in performance between the first container record and the second container record.

2. The system of claim 1, wherein the trigger comprises at least one of:
a periodic trigger, wherein the periodic trigger is based on a time interval;
an action trigger, wherein the action trigger is based on the container being reconfigured; or
a user trigger, wherein the user trigger is based on a user causing the trigger to be initiated.

3. The system of claim 1, wherein the first container record comprises a snapshot of the container comprising a copy of the container's state including file values, performance metrics, and error evaluations.

4. The system of claim 1, wherein the second container record comprises a snapshot of the container comprising, in an instance in which the trigger is initiated, a copy of the container's state including file values, performance metrics, and error evaluations.

5. The system of claim 1, wherein the second container record comprises a snapshot of the reconfigurations of the container made prior to an instance in which the trigger is initiated.

6. (canceled)

7. The system of claim 1, wherein determining the difference between the first container record and the second container record further comprises using the artificial intelligence (AI) model to perform statistical calculations on the change in performance between the first container record and the second container record.

8. The system of claim 7, wherein the statistical calculations comprise automated outlier techniques.

9. A computer program product for database configurations using advanced computational models for data analysis and automated processing, the computer program product comprising a non-transitory computer-readable medium comprising code causing an apparatus to:
receive a first container record comprising data associated with a container, wherein the container comprises a standalone executable package;
store the first container record in a first database;
receive a trigger, wherein the trigger causes a generation of a second container record comprising data associated with the container, wherein the second container record is generated after the first container record;
store the second container record in a second database; and
determine, using an artificial intelligence (AI) model, a difference between the first container record and the second container record, wherein the difference affects at least one of an application, a file, or an additional container associated with the container, and wherein the difference indicates a change in performance between the first container record and the second container record.

10. The computer program product of claim 9, wherein the trigger comprises at least one of:
a periodic trigger, wherein the periodic trigger is based on a time interval;
an action trigger, wherein the action trigger is based on the container being reconfigured; or
a user trigger, wherein the user trigger is based on a user causing the trigger to be initiated.

11. The computer program product of claim 9, wherein the first container record comprises a snapshot of the container comprising a copy of the container's state including file values, performance metrics, and error evaluations.

12. The computer program product of claim 9, wherein the second container record comprises a snapshot of the container comprising, in an instance in which the trigger is initiated, a copy of the container's state including file values, performance metrics, and error evaluations.

13. The computer program product of claim 9, wherein the second container record comprises a snapshot of the reconfigurations of the container made prior to an instance in which the trigger is initiated.

14. (canceled)

15. The computer program product of claim 9, wherein determining the difference between the first container record and the second container record further comprises using the artificial intelligence (AI) model to perform statistical calculations on the change in performance between the first container record and the second container record.

16. The computer program product of claim 15, wherein the statistical calculations comprise automated outlier techniques.

17. A method for database configurations using advanced computational models for data analysis and automated processing, the method comprising:
receiving a first container record comprising data associated with a container, wherein the container comprises a standalone executable package;
storing the first container record in a first database;
receiving a trigger, wherein the trigger causes a generation of a second container record comprising data associated with the container, wherein the second container record is generated after the first container record;
storing the second container record in a second database; and
determining, using an artificial intelligence (AI) model, a difference between the first container record and the second container record, wherein the difference affects at least one of an application, a file, or an additional container associated with the container, and wherein the difference indicates a change in performance between the first container record and the second container record.

18. The method of claim 17, wherein the trigger comprises at least one of:
a periodic trigger, wherein the periodic trigger is based on a time interval;
an action trigger, wherein the action trigger is based on the container being reconfigured; or
a user trigger, wherein the user trigger is based on a user causing the trigger to be initiated.

19. The method of claim 17, wherein the first container record comprises a snapshot of the container comprising a copy of the container's state including file values, performance metrics, and error evaluations.

20. The method of claim 17, wherein the second container record comprises a snapshot of the container comprising, in an instance in which the trigger is initiated, a copy of the container's state including file values, performance metrics, and error evaluations.
